(19) United States
(12) Patent Application Publication
(10) Pub. No.: US 2006/0092143 A1
(43) Pub. Date: May 4, 2006

(54) Touch panel device and method for sensing a touched position

(76) Inventors: Naruhiko Kasai, Yokohama (JP); Hajime Akimoto, Kokubunji (JP); Hiroshi Kageyama, Hachioji (JP)

Correspondence Address: MCDERMOTT WILL & EMERY LLP, 600 13TH STREET, N.W., WASHINGTON, DC, 20005-3096, US

(21) Appl. No.: 11/260,484

(22) Filed: Oct. 28, 2005

(30) Foreign Application Priority Data
Oct. 28, 2004 (JP) 2004-313772

(51) Int. Cl. G09G 5/00

(52) U.S. Cl. 345/175

(57) ABSTRACT

Sensors are arranged in matrix form on a touch panel device. The touch panel device is provided with a P/S conversion circuit having the X-coordinate scan range change function and a P/S conversion circuit having the Y-coordinate scan range change function according to the similar configuration. When a touch is sensed, a scan range is limited around the touched position. This makes it possible to increase a speed of detecting an X coordinate signal and a Y coordinate signal without accelerating a scan shift clock.

### BACKGROUND OF THE INVENTION

The present invention relates to a touch panel device with sensors arranged in matrix form and a coordinate detection control method of the same. More specifically, the present invention relates to a touch panel device and a coordinate detection control method thereof for implementing high-speed coordinate sensing compatible with pen input.

The touch panel arranged in matrix form detects changes of pulses from the directions of X and Y axes by scanning on the screen to sense which sensor is touched. JP-A-7-281813 describes the following considerations (1) through (8) to improve the sensing efficiency.

(1) The Y direction scanning starts only when the X-direction scanning senses a touch. (2) Only predetermined areas are scanned. (3) A finder touch is scanned skippingly. (4) The scanning terminates at a touched position. (5) A area is divided into blocks that are then scanned parallel. (6) The X and Y directions are scanned simultaneously. (7) A scanning ratio is increased in advance for frequently touched areas. (8) Normally, areas are scanned skippingly, but are scanned without skipping when a touch is sensed.

### SUMMARY OF THE INVENTION

However, JP-A-7-281813 gives no consideration to high-speed sensing such as pen input. The above-mentioned considerations (1) through (8) are accompanied by the following problems (1) through (8) as concerns high-speed sensing.

(1) The entire screen is scanned at the same speed, always necessitating high-speed sensing to be compatible with handwritten input. (2) The touch area is limited. (3) No pen input is available. (4) Touching the bottom right of the screen gives no effect for acceleration. (5) Acceleration is easy, but the number of output lines increases. (6) The entire screen is scanned at the same speed, always necessitating high-speed sensing to be compatible with handwritten input. (7) The screen and the touch area are limited. (8) The speed for touch sensing becomes slower than the normal state, i.e., a wait for touch.

An aspect of the present invention resides in a parallel-serial conversion circuit which has a coordinate scan range change function on each of X-direction and Y-direction sensor lines.

The parallel-serial conversion circuit having the coordinate scan range change function provided on the sensor line supplies a parallel-serial conversion clock as the only control signal from the outside. It is possible to accelerate scan operations by limiting the sensor scanning range during pen input.

Consequently, the aspect of the-present invention is used for touch panels mounted on cellular phones and small terminals or constructed on the same glass substrate.

### BRIEF DESCRIPTION OF THE DRAWINGS

Embodiments of the present invention will be described in detail based on the following figures, wherein:

FIG. 1 shows the configuration of a touch panel device according to an embodiment of the present invention;

FIG. 2 shows the internal configuration of an X1Y1 sensor 13 out of sensors 13 through 24 as shown in FIG. 1;

FIG. 3 shows an example of changes in voltages for sensor lines 3 through 6 and 9 through 11 as shown in FIG. 1 when an X2Y2 sensor 18 (grayed) is touched;

FIG. 4 shows the internal configuration of a P/S conversion circuit 2 having an X-coordinate scan range change function as shown in FIG. 1;

FIG. 5 shows the concept of a scan range change operation by the P/S conversion circuit 2 having the X-coordinate scan range change function in FIG. 4 according to untouched and touched conditions;

FIG. 6 shows the concept of a scan range change operation by the P/S conversion circuit 2 having the X-coordinate scan range change function in FIG. 4 when a touched position is moved;

FIG. 7 shows in detail an untouched operation by the P/S conversion circuit 2 having the X-coordinate scan range change function in FIG. 4;

FIG. 8 shows in detail an operation to start touching by the P/S conversion circuit 2 having the X-coordinate scan range change function in FIG. 4 when a sensor positioned to X50 is touched; and

FIG. 9 shows in detail an operation to move the touched position by the P/S conversion circuit 2 having the X-coordinate scan range change function in FIG. 4 when a sensor positioned to X90 is touched.

### DETAILED DESCRIPTION OF THE PREFERRED EMBODIMENTS

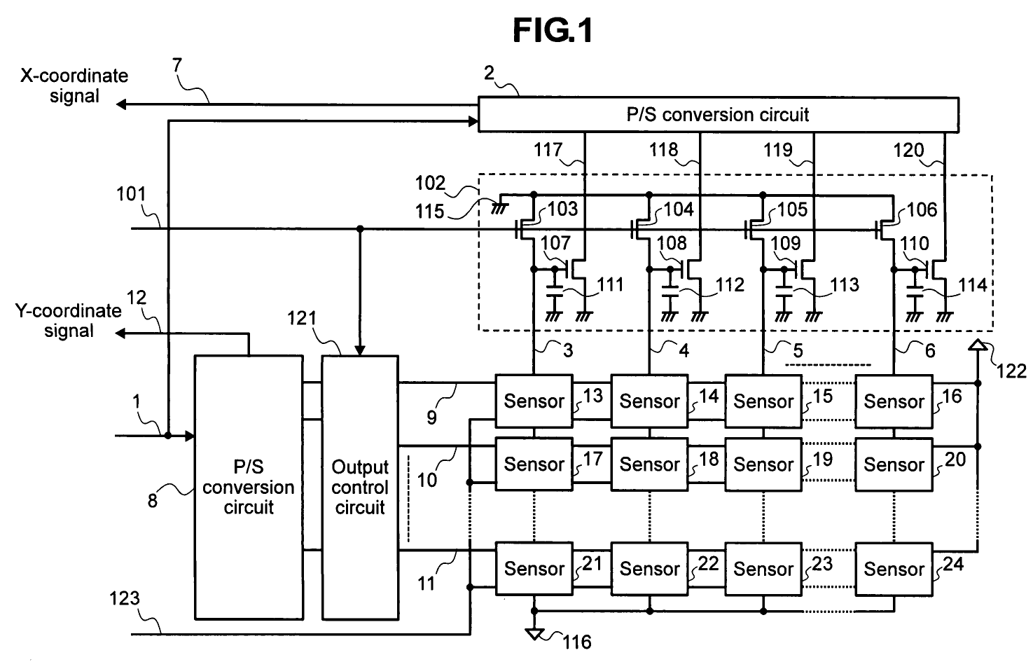

FIG. 1 exemplifies a touch panel device according to an embodiment of the present invention. In FIG. 1, reference numeral 1 denotes a scan shift clock; 2 denotes a P/S conversion circuit having an X-coordinate scan range change function; 3 denotes an X1 sensor line; 4 denotes an X2 sensor line; 5 denotes an X3 sensor line; 6 denotes an X240 sensor line; and 7 denotes an X-coordinate signal. When no touch is made, the P/S conversion circuit 2 having the X-coordinate scan range change function scans all lines from the X1 sensor line 3 to the X240 sensor line 6 according to the scan shift clock 1. The P/S conversion circuit 2 P/S-converts voltage change signals for the respective sensor lines and outputs a result as the X-coordinate signal 7. When a touch is made, the P/S conversion circuit 2 scans the limited number of sensor lines around the touched position. The P/S conversion circuit 2 P/S-converts voltage change signals for the respective sensor lines and outputs a result as the X-coordinate signal 7. The parallel/serial conversion of signals is optional.

In the following description of the embodiment, it is assumed that there are 240 X-direction sensor lines, i.e., the sensor line 6 corresponds to a X240 sensor line and that sensor lines to be scanned are limited 80 lines during touch sensing.

Reference numeral 8 denotes a P/S conversion circuit having a Y-coordinate scan range change function; 9 denotes a Y1 sensor line; 10 denotes a Y2 sensor line; 11 denotes a Y320 sensor line; and 12 denotes a Y-coordinate signal. Similarly to the X coordinate, when no touch is made, the P/S conversion circuit 8 having the Y-coordinate scan range change function scans all lines from the Y1 sensor line 9 to the Y320 sensor line 11 according to the scan shift clock 1. The P/S conversion circuit 8 P/S-converts voltage change signals for the respective sensor lines and outputs a result as the Y-coordinate signal 12. When a touch is made, the P/S conversion circuit 8 scans the limited number of sensor lines around the touched position. The P/S conversion circuit 8 P/S-converts voltage change signals for the respective sensor lines and outputs a result as the Y-coordinate signal 12. The parallel/serial conversion of signals is optional.

In the following description of the embodiment, it is assumed that there are 320 Y-direction sensor lines, i.e., the sensor line 11 corresponds to a Y320 sensor line and that sensor lines to be scanned are limited 80 lines during touch sensing.

Accordingly, the touch panel according to the embodiment has the 240×320 resolution. When a touch is sensed, the scan range corresponds to an area of 80 dots by 80 lines.

Reference numeral 13 denotes an X1Y1 sensor; 14 denotes an X2Y1 sensor; 15 denotes an X3Y1 sensor; 16 denotes an X240Y1 sensor; 17 denotes an X1Y2 sensor; 18 denotes an X2Y2 sensor; 19 denotes an X3Y2 sensor; 20 denotes an X240 Y2 sensor; 21 denotes an X1Y320 sensor; 22 denotes an X2Y320 sensor; 23 denotes an X3Y320 sensor; and 24 denotes an X240 Y320 sensor.

Reference numeral 101 denotes a sensor line reset signal; 102 denotes an X sensor line output control circuit; 103 denotes an X1 sensor line reset switch; 104 denotes an X2 sensor line reset switch; 105 denotes an X3 sensor line reset switch; and 106 denotes an X240 sensor line reset switch.

Reference numeral 107 denotes an X1 sensor line output buffer; 108 denotes an X2 sensor line output buffer; 109 denotes an X3 sensor line output buffer; and 110 denotes an X240 sensor line output buffer.

Reference numeral 111 denotes an X1 sensor line buffer capacitor; 112 denotes an X2 sensor line buffer capacitor; 113 denotes an X3 sensor line buffer capacitor; and 114 denotes an X240 sensor line buffer capacitor.

Reference numeral 115 denotes an X sensor line reset voltage; 116 denotes an X sensor line charge voltage; 117 denotes an X1 output line; 118 denotes an X2 output line; 119 denotes an X3 output line; and 120 denotes an X240 output line.

The X1 sensor line reset switch 103 through the X240 sensor line reset switch 106 turn on or off according to the sensor line reset signal 101 that supplies reset timing at a given cycle. The sensor line reset switches 103 through 106 reset the X1 sensor line 3 through the X240 sensor line 6 to the X sensor line reset voltage 115, respectively.

At this time, gate voltages from the X1 sensor line output buffer 107 through the X240 sensor line output buffer 110 are also reset to the X sensor line reset voltage.

After the reset is released, the X1 sensor line buffer capacitor 111 through the X240 sensor line buffer capacitor 114 are charged with the X sensor line charge voltage 116 in accordance with a time constant that varies with the sensor's touched or untouched condition.

Accordingly, gate voltages from the X1 sensor line output buffer 107 through the X240 sensor line output buffer 110 vary with the touched or untouched condition. This voltage difference is used for ON/OFF control.

The X1 output line 117 through the X240 output line 120 are sequentially connected to the X coordinate signal 7 already initialized to a fixed voltage via the P/S conversion circuit 2 having the X-coordinate scan range change function. The output lines 117 through 120 cause voltage variations in accordance with ON/OFF operations of the X1 sensor line output buffer 107 through the X240 sensor line output buffer 110. This voltage variation is output as the X coordinate signal 7.

In the following description of the embodiment, it is assumed that the X sensor line reset voltage 115 is set to ground (GND) 0 V and the X sensor line charge voltage 116 is set to 10 V.

Reference numeral 121 denotes a Y sensor line output control circuit; and 122 denotes a Y sensor line charge voltage. The Y sensor line output control circuit 121 has completely the same configuration as the X sensor line output control circuit 102. The Y sensor line output control circuit 121 resets the sensor line to GND according to the reset timing and then is changed (charged) to the Y sensor line charge voltage 122 based on the time constant in accordance with the sensor's touched or untouched condition.

Reference numeral 123 denotes a sensor reset signal. The sensors 13 through 24 reset loads to the initial states in accordance with the timing of the sensor reset signal 123. After the reset is released, each sensor's load is varied in accordance with the sensor's touched or untouched condition to change the time constants for the X sensor lines 3 through 6 and the Y sensor lines 9 through 11. Charge speeds for the X sensor line charge voltage 116 and the Y sensor line charge voltage 122 are varied in accordance with the sensor's touched or untouched condition.

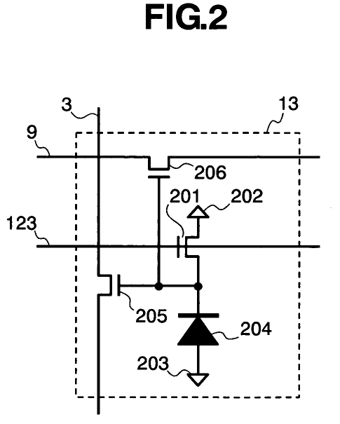

FIG. 2 shows the internal configuration of the X1Y1 sensor 13 out of the sensors 13 through 24 as shown in FIG. 1. The same configuration applies to the X2Y1 sensor 14 through the X240 Y320 sensor 24.

In FIG. 2, reference numeral 201 denotes a sensor reset switch; 202 denotes a positive sensor power supply; 203 denotes a negative sensor power supply; 204 denotes a photodiode; 205 denotes an X coordinate buffer; and 206 denotes a Y coordinate buffer. The sensor reset switch 201 turns on in accordance with the timing of the sensor reset signal 123. At this time, the sensor power supply 202 equals the negative sensor power supply 203. This resets the gate voltages of the X coordinate buffer 205 and the Y coordinate buffer 206 equally to the voltage of the positive sensor power supply 202.

After the reset is released, the negative sensor power supply 203 is set to be lower than the positive sensor power supply 202. The sensor reset switch 201 is turned off in accordance with the sensor reset signal 123. In this manner, the photodiode is supplied with an electric current corresponding to the light.

The following description assumes that a touched condition allows the light to be applied and the electric current to flow and that an untouched condition prevents the light from being applied and the electric current from flowing. Further, the following description assumes that the positive sensor power supply 202 is set to 6V and the negative sensor power supply 203 after releasing the reset is set to GND (0 V).

The gate voltage for the X coordinate buffer 205 and the Y coordinate buffer 206 is subject to voltage change ΔV expressed by equation 1, where I_{D} is the current applied to the photodiode 25, C_{B} the capacity of each buffer, and t the touch time.
ΔV=I_{D}×t/C_{B} (Equation 1)

That is, an electric current flows when no touch is sensed. Accordingly, the gate voltage for the X coordinate buffer 205 and the Y coordinate buffer 206 is found by decreasing Δ V from 6 V for the positive sensor power supply 202. No electric current flows when a touch is sensed. Accordingly, the gate voltage for the X coordinate buffer 205 and the Y coordinate buffer 206 equals 6 V for the positive sensor power supply 202.

This voltage change accordingly changes loads (ON resistance) for the X coordinate buffer 205 and the Y coordinate buffer 206 and time constants for the X1 sensor line 3 and the Y1 sensor line 9.

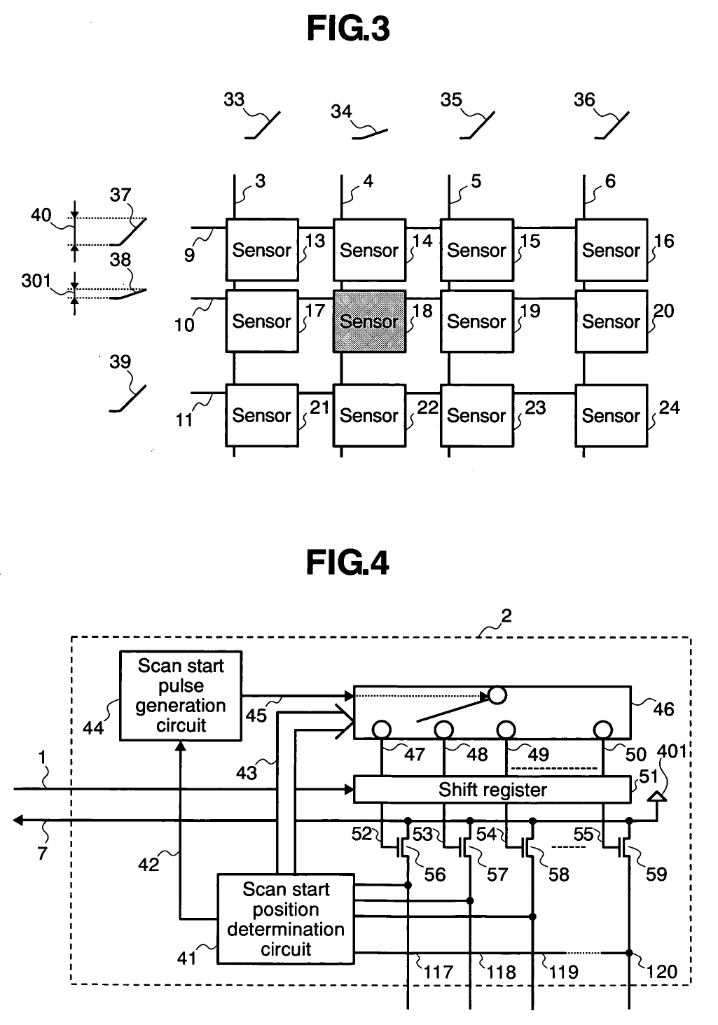

FIG. 3 shows an example of changes in voltages for the X sensor lines 3 through 6 and the Y sensor lines 9 through 11 as shown in FIG. 1 when the X2Y2 sensor 18 (grayed) is touched.

In FIG. 3, reference numeral 33 denotes an X1 sensor line waveform; 34 denotes an X2 sensor line waveform; 35 denotes an X3 sensor line waveform; 36 denotes an X240 sensor line waveform; 37 denotes a Y1 sensor line waveform; 38 denotes a Y2 sensor line waveform; 39 denotes a Y320 sensor line waveform; 301 denotes a voltage change amount for touched condition; and 40 denotes a voltage change amount for untouched condition. Due to untouched conditions, the X1 sensor line waveform 33, the X3 sensor line waveform 35, the X240 sensor line waveform 36, the Y1 sensor line waveform 37, and the Y320 sensor line waveform 39 cause small time constants for the sensor lines. The voltage change amount for untouched condition 40 increases.

Due to touched conditions, the X2 sensor line waveform 34 and the Y2 sensor line waveform 38 cause large time constants for the sensor lines. The voltage change amount for touched condition 301 decreases.

FIG. 4 exemplifies the internal configuration of the P/S conversion circuit 2 having the X-coordinate scan range change function as shown in FIG. 1. The same configuration is used for the P/S conversion circuit 8 having the Y-coordinate scan range change function.

In FIG. 4, reference numeral 41 denotes a scan start position determination circuit; 42 denotes a touch sensing signal; and 43 denotes a scan start position signal. The scan start position determination circuit 41 senses the presence or absence of a touch based on changes in the signal voltages for the sensor lines 3 through 6 and outputs a result as the touch sensing signal 42.

When an “untouched condition” is sensed, the scan start position determination circuit 41 outputs the scan start position signal 43 set to “1” indicating the left end out of 1 through 240 (or 1 through 320 along the Y coordinate) as scan start positions according to the embodiment. When a “touched condition” is sensed, the scan start position determination circuit 41 determines a touched coordinate. Around the determined coordinate, the scan start position determination circuit 41 determines the scan start position so as to determine the scan range of 80 lines according to the embodiment. The scan start position determination circuit 41 outputs the scan start position as the scan start position signal 43.

As an example of the method for determining the scan start position, scan start position P_{S} is expressed by equation 2 as follows, where X_{D} is the detected coordinate and D_{S} the scan range.
P_{S}=X_{D}−(D_{S}/2)−1 (Equation 2)

Reference numeral 44 denotes a scan start pulse generation circuit; and 45 denotes a scan start pulse. According to the touch sensing signal 42, the scan start pulse generation circuit 44 generates a scan start pulse 45 indicative of one scan cycle.

When the touch sensing signal indicates an “untouched condition,” the scan start pulse generation circuit 44 outputs the scan start pulse 45 at a cycle to scan the X sensor line 240. When the touch sensing signal indicates a “touched condition,” the scan start pulse generation circuit 44 outputs the scan start pulse 45 at a cycle to limit the scan range for scanning 80 lines, i.e., at a cycle shorter than that for the “untouched condition.”

Reference numeral 46 denotes an scan start position switch; 47 denotes an X1 scan start input; 48 denotes an X2 scan start input; 49 denotes an X3 scan start input; and 50 denotes an X240 scan start input. The scan start position signal 46 indicates the X1 through X240 scan start inputs 47 through 50 corresponding to the X1 through X240 sensor lines represented by 1 through 240. The scan start position switch 46 selectively outputs the scan start pulse 45 to one of these scan start inputs.

Reference numeral 51 denotes a shift register; 52 denotes an X1 selection line; 53 denotes an X2 selection line; 54 denotes an X3 selection line; 55 denotes an X240 selection line; 56 denotes an X1 selection switch; 57 denotes an X2 selection switch; 58 denotes an X3 selection switch; 59 denotes an X240 selection switch; and 401 denotes an X coordinate output power supply. The scan start pulse 45 is supplied from any one of the scan start inputs 47 through 50. The shift register 51 outputs the scan start pulse 45 from anyone of the selection lines 52 through 54 corresponding to the inputs. The shift register 51 sequentially shifts to the right in accordance with the scan shift clock 1 to output pulses.

When no touch is sensed, for example, the scan start pulse 45 is supplied from the X1 scan start input 47. The shift register 51 sequentially shifts from the X1 selection line 52, the X2 selection line 53, and so on to the right to output pulses.

Let us assume that a touch is sensed and the scan start pulse 45 is supplied from the X2 scan start input 48. The shift register 51 sequentially shifts from the X2 selection line 53, the X3 selection line 54, and soon to the right to output pulses. No pulse is output from the X1 selection line 52. In this case, the scan start position signal 43 outputs the start position “2.”

Finally, the X1 selection line 56 through the X240 selection line 55 sequentially turn on to allow the X1 selection switch 56 through the X240 selection switch 59 to sequentially connect the X1 output line 117 through the X240 output line 120 with the X coordinate signal 7.

The X coordinate signal 7 is connected to the X coordinate output power supply 401. The X1 output line 117 through the X240 output line 120 are connected to the X1 sensor line output buffer 107 through the X240 sensor line output buffer 110 in FIG. 1. Accordingly, voltages of the X1 output line 117 through the X240 output line 120 change from the initial X coordinate output power supply 401 in accordance with gate voltages of the X1 sensor line output buffer 107 through the X240 sensor line output buffer 110 that vary with the touched or untouched condition. This voltage change is serially output via the X coordinate signal 7.

FIG. 5 shows the concept of a scan range change operation by the P/S conversion circuit 2 having the X-coordinate scan range change function in FIG. 4 according to untouched and touched conditions.

In FIG. 5, reference numeral 60 denotes a touch panel mounting and display area; 61 denotes a coordinate scan range for untouched condition; 62 denotes a pen touch start position; and 63 denotes a coordinate scan range for initiated touch. Before the pen touch start position 62 is touched, the coordinate scan range for untouched condition 61 corresponds to the whole of the touch panel mounting and display area 60. When the pen touch start position 62 is touched, the scan range equals to the coordinate scan range for initiated touch 63.

According to the embodiment, the touch panel mounting and display area 60 is assumed to be 240×320 dots. The coordinate scan range for initiated touch 63 is assumed to be 80×80 dots.

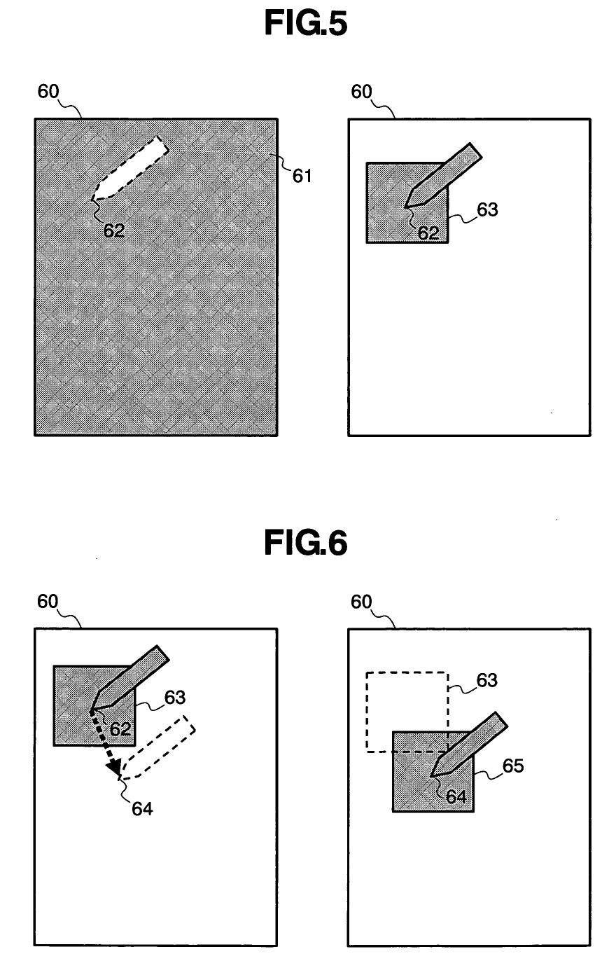

FIG. 6 shows the concept of a scan range change operation by the P/S conversion circuit 2 having the X-coordinate scan range change function in FIG. 4 when a touched position is moved.

In FIG. 6, reference numeral 64 denotes a moved pen touch position; and 65 denotes a coordinate scan range for moved touch. When the pen position moves from the pen touch start position 62 to the moved pen touch position 64, the scan range moves from the coordinate scan range for initiated touch 63 to the coordinate scan range for moved touch 65. Accordingly, the scan range always follows the pen tip.

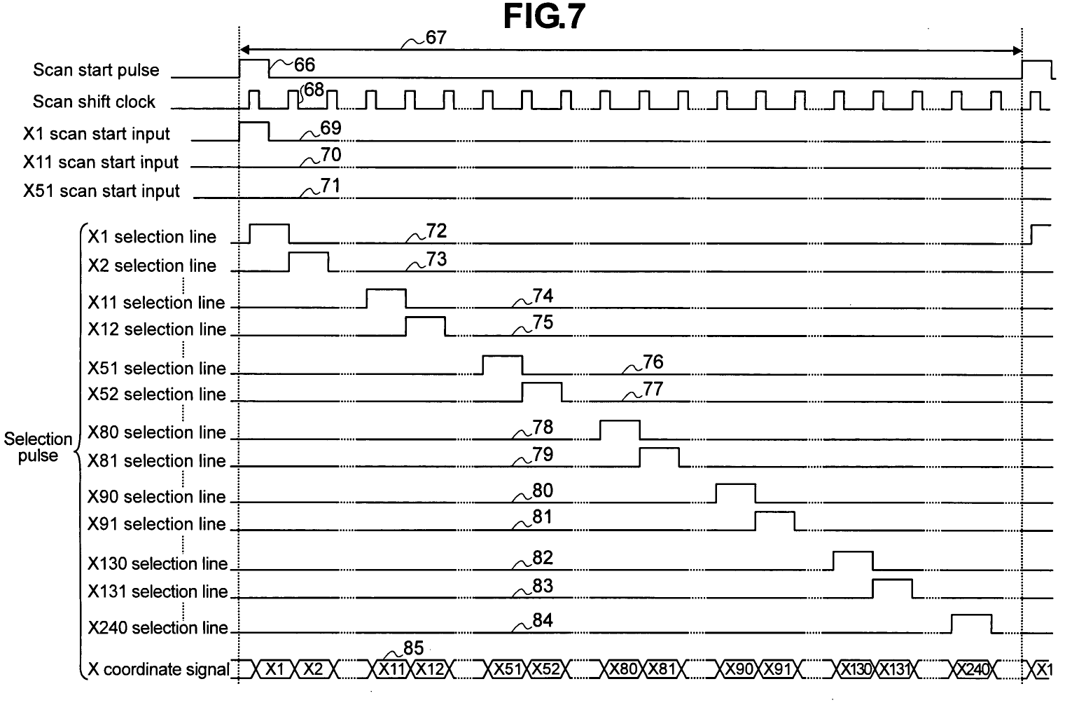

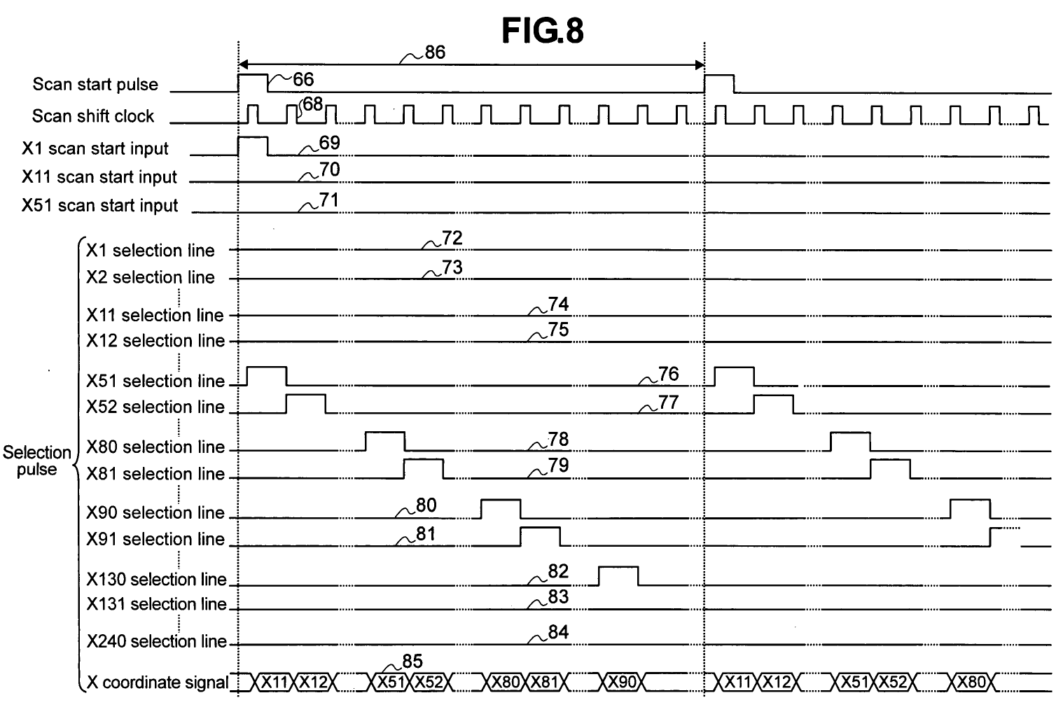

FIG. 7 shows in detail an untouched operation by the P/S conversion circuit 2 having the X-coordinate scan range change function in FIG. 4.

In FIG. 7, reference numeral 66 denotes a scan start pulse waveform; 67 denotes a scan start pulse cycle for untouched condition; 68 denotes a scan shift clock waveform; 69 denotes an X1 scan start input waveform; 70 denotes an X11 scan start input waveform; 71 denotes an X51 scan start input waveform; 72 denotes an X1 selection line waveform; 73 denotes an X2 selection line waveform; 74 denotes an X11 selection line waveform; 75 denotes an X12 selection line waveform; 76 denotes an X51 selection line waveform; 77 denotes an X52 selection line waveform; 78 denotes an X80 selection line waveform; 79 denotes an X81 selection line waveform; 80 denotes an X90 selection line waveform; 81 denotes an X91 selection line waveform; 82 denotes an X130 selection line waveform; 83 denotes an X131 selection line waveform; 84 denotes an X240 selection line waveform; and 85 denotes an X coordinate signal waveform.

When no touch is sensed, the scan start pulse cycle for untouched condition 67 signifies the time to scan all lines. The description to follow assumes that 240 lines are scanned in the X direction and 320 lines are scanned in the Y direction.

When no touch is sensed, a scan start pulse is supplied to the X1 scan start input. The X1 scan start input waveform 69 becomes similar to the scan start pulse waveform 66. Other than the X11 scan start input waveform 70 and the X51 scan start input waveform 71, no pulse is supplied except the X1 scan start input waveform 69.

The X1 scan start input waveform 69 is shiftingly applied as a pulse to all the selection lines in order such as the X1 selection line waveform 72, the X2 selection line waveform 73, and so on, the X11 selection line waveform 74, the X12 selection line waveform 75, and so on, the X51 selection line waveform 76, the X52 selection linewave form 77, and so on, the X80 selection line waveform 78, the X81 selection line waveform 79, and so on, the X90 selection line waveform 80, the X91 selection line waveform 81, and so on, the X130 selection line waveform 82, the X131 selection line waveform 83, and so on, and the X240 selection line waveform 84 in accordance with the scan shift clock waveform 68.

The X coordinate signal line waveform 85 outputs the signal states of the sensor lines, i.e., the touch states, in accordance with the pulses on the selection lines. This signifies that the X coordinate is serialized and is output.

Although not shown, the scan start pulse is always preceded by the sensor line reset signal 101 and the sensor reset signal 123 for a reset operation.

FIG. 8 shows in detail an operation to start touching by the P/S conversion circuit 2 having the X-coordinate scan range change function in FIG. 4 when a sensor positioned to X50 is touched.

In FIG. 8, reference numeral 66 denotes a scan start pulse cycle for touched condition. When a touch is sensed, the scan start pulse cycle for touched condition 86 indicates the time to scan 80 lines according to the embodiment.

When the sensor positioned to X50 is touched, the embodiment determines the scan start position to be “11” according to equation 2. The scan start pulse is supplied to the X11 scan start input. The X11 scan start input waveform 70 becomes similar to the scan start pulse waveform 66. Other than the X1 scan start input waveform 69 and the X51 scan start input waveform 71, no pulse is supplied except the X11 scan start input waveform 70.

The X11 scan start input waveform 70 is shiftingly applied as a pulse to 80 selection lines in order such as the X11 selection line waveform 74, the X12 selection line waveform 75, and so on, the X51 selection line waveform 76, the X52 selection line waveform 77, and so on, the X80 selection line waveform 78, the X81 selection line waveform 79, and so on, and the X90 selection line waveform 80 in accordance with the scan shift clock waveform 68.

The scan range does not include the X1 selection line 72, the X2 selection line 73, the X91 selection line 81, the X130 selection line 82, the X131 selection line 83, and the X240 selection line 84. Except these selection lines, no pulse is output to the selection lines other than X11 through X90.

The X coordinate signal line waveform 85 outputs the signal states of the sensor lines, i.e., the touch states, in accordance with the pulses on the selection lines. This signifies that the X coordinate for X11 through X90 is serialized and is output.

Again, although not shown, the scan start pulse is always preceded by the sensor line reset signal 101 and the sensor reset signal 123 for a reset operation.

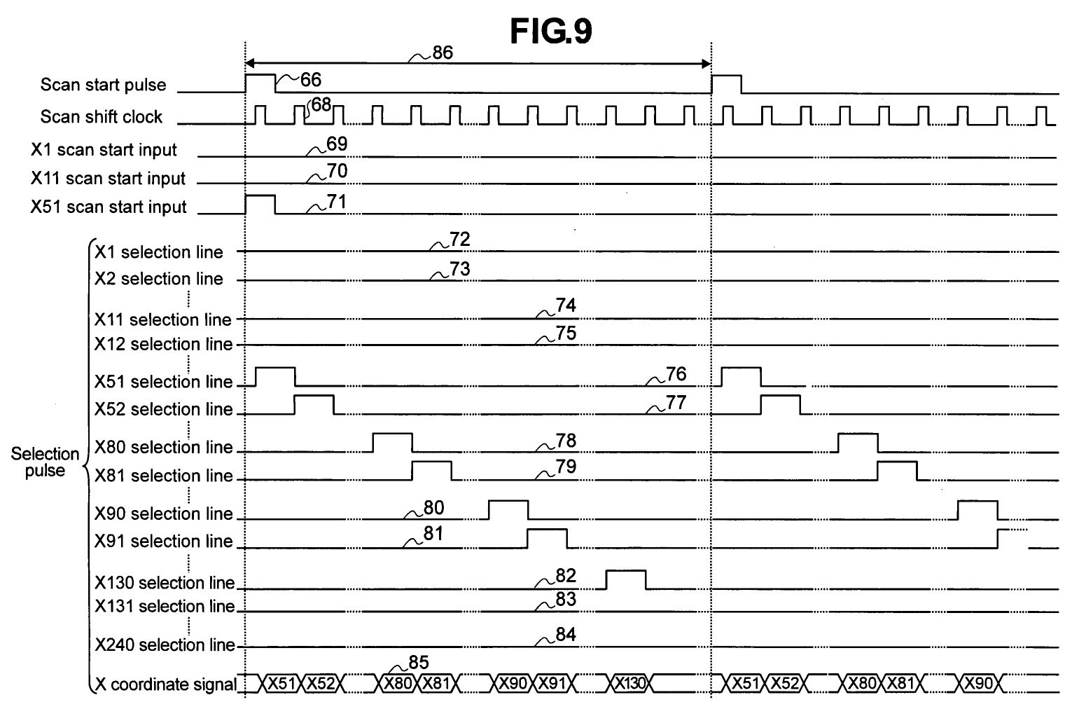

FIG. 9 shows in detail an operation to move the touched position by the P/S conversion circuit 2 having the X-coordinate scan range change function in FIG. 4 when a sensor positioned to X90 is touched.

In FIG. 9, when a touch is moved, the scan start pulse cycle for touched condition 86 indicates the time to scan 80 lines according to the embodiment similarly to the initiated touch. When the sensor positioned to X90 is touched, the embodiment determines the scan start position to be “51” according to equation 2. The scan start pulse is supplied to the X51 scan start input. The X51 scan start input waveform 71 becomes similar to the scan start pulse waveform 66. Other than the X1 scan start input waveform 69 and the X11 scan start input waveform 70, no pulse is supplied except the X51 scan start input waveform 71.

The X51 scan start input waveform 71 is shiftingly applied as a pulse to 80 selection lines in order such as the X51 selection line waveform 76, the X52 selection line waveform 77, and so on, the X80 selection line waveform 78, the X81 selection line waveform 79, and so on, the X90 selection line waveform 80, the X91 selection line waveform 81, and so on, and the X130 selection line waveform 82 in accordance with the scan shift clock waveform 68.

The scan range does not include X1 selection line 72, the X2 selection line 73, the X11 selection line 74, the X12 selection line 75, the X131 selection line 83, and the X240 selection line 84. Except these selection lines, no pulse is output to the selection lines other than X51 through X130.

The X coordinate signal line waveform 85 outputs the signal states of the sensor lines, i.e., the touch states, in accordance with the pulses on the selection lines. This signifies that the X coordinate for X51 through X130 is serialized and is output.

Again, although not shown, the scan start pulse is always preceded by the sensor line reset signal 101 and the sensor reset signal 123 for a reset operation.

With reference to FIGS. 1 through 9, the following describes the coordinate detection control method for the touch panel device according to the embodiment. First, FIGS. 1 and 5 are used to describe flows of the coordinate detection.

In FIG. 1, the sensors 13 through 24 detect the presence or absence of touching in terms of electric current variations due to the light. The electric current variations indicate load variations for the connected X sensor lines 3 through 6 and Y sensor lines 9 through 11. The detail will be described later.

Load variations for the X sensor lines 3 through 6 and the Y sensor lines 9 through 11 result in variations of the charge time for the X sensor line charge voltage 116 and the Y sensor line charge voltage 122. Depending on the touched or untouched condition, load variations for the X sensor lines 3 through 6 and the Y sensor lines 9 through 11 result in differences of gate voltages for the X1 sensor line output buffer 107 through the X240 sensor line output buffer 110.

The X1 sensor line output buffer 107 through the X240 sensor line output buffer 110 turn on or off according to the gate voltage differences.

The P/S conversion circuit 2 having the X-coordinate scan range change function sequentially connects the X1 output line 117 through the X240 output line 120 to the X coordinate signal 7 in accordance with the scan shift clock 1. The P/S conversion circuit 2 having the X-coordinate scan range change function parallel outputs voltage variations due to on/off operations of the X1 sensor line output buffer 107 through the X240 sensor line output buffer 110. At this time, an untouched condition causes P/S conversion of 240 lines on the entire touch panel. A touched condition causes P/S conversion of 80 lines. The detail will be described later.

The P/S conversion circuit 8 having the Y-coordinate scan range change function serially converts the parallel output voltage variations of the Y sensor lines in accordance with the scan shift clock 1 and outputs a result as the Y coordinate signal 12. At this time, an untouched condition causes P/S conversion of 320 lines on the entire touch panel. A touched condition causes P/S conversion of 80 lines. The detail will be described later.

Accordingly, as shown in FIG. 5, an untouched condition allows the entire touch panel mounting and display area 60 to be scanned. A touched condition allows only the coordinate scan range for initiated touch 63 to be scanned.

The touch panel according to the embodiment is composed of 240×320 dots. The touched scan range is composed of 80×80 dots. The present invention is not limited to this touch panel configuration. In particular, the touched scan range can be changed in accordance with pen input speeds.

FIGS. 2 and 3 are used to detail operations of sensing the touched sensors as shown in FIG. 1. In FIG. 2, an untouched condition allows the light to be applied to the photodiode 204 and an electric current to flow. A touched condition hides the light and prevents an electric current from flowing.

According to the electric current, gate voltages for the X coordinate buffer 205 and the Y coordinate buffer 206 cause voltage variation ΔV as shown in equation 1. Accordingly, the X sensor line 3 and the Y sensor line 9 are subject to a small load when untouched or a large load when touched.

As a result, when the sensor 18 grayed in FIG. 3 is touched, the X1 sensor line 3, the X3 sensor line 5, the X240 sensor line 6, the Y1 sensor line 9, and the Y320 sensor line 11 are untouched. These sensor lines cause the voltage change amount for untouched condition 40 corresponding to a large variation. The X2 sensor line 4 and the Y2 sensor line 10 cause the voltage change amount for touched condition 301 corresponding to a small variation. The touched portion causes a voltage difference between the sensor lines and becomes detectable.

The sensor according to the embodiment uses the photodiode to detect the light. A photodetector circuit can also use an off-leak current due to the light based on the a-Si or low-temperature poly-Si TFT technology. The present invention is not limited to the above-mentioned sensor configuration and may be applicable to any methods that use voltage variations for touch detection.

FIGS. 4 and 6 through 9 are used to detail the coordinate detection acceleration by means of coordinate scan range change performed by the P/S conversion circuit 2 having the X-coordinate scan range change function and the P/S conversion circuit 8 having the Y-coordinate scan range change function as shown in FIG. 1.

In FIG. 4, the scan start position determination circuit 41 detects the presence or absence of a voltage variation in the sensor output lines 117 through 120 and outputs a result as the touch sensing signal 42.

When there is no sensor line indicative of a touched condition, the scan start position is set to “1” to output the scan start position signal 43. When there is a sensor line indicative of a touched condition, the scan start position is determined from that sensor line according to equation 2 to output the scan start position signal 43. When a touch is sensed, the scan start position signal 43 is always determined according to equation 2. When the pen is moved as shown in FIG. 6, the scan start position also moves.

FIG. 7 is used to detail operations to generate the X coordinate signal 7 in an untouched condition by means of the scan start pulse generation circuit 44, the scan start position switch 46, the shift register 51, and the selection switches 56 through 59 as shown in FIG. 4.

In FIG. 7, the scan start pulse cycle for untouched condition 67 represents a cycle for the scan start pulse waveform 66 in untouched condition and is equivalent to 240 lines. The scan start pulse is input to the X1 scan start input. Pulses are sequentially output to all the selection lines. As a result, the X coordinate signal line waveform 85 indicates that all voltage levels for the X1 sensor line 3 through the X240 sensor line 6 are serially converted and output. Therefore, the detection time is assumed to be 240 times the cycle of the scan shift clock 68.

FIGS. 8 and 9 are used to detail operations to generate the X coordinate signal 7 in a touched condition by means of the scan start pulse generation circuit 44, the scan start position switch 46, the shift register 51, and the selection switches 56 through 59 as shown in FIG. 4.

In FIG. 8, the scan start pulse cycle for touched condition 86 represents a cycle for the scan start pulse waveform 66 in touched condition and is equivalent to 80 lines. When the touched position corresponds to X50, the scan start pulse is input to the X11 scan start input. Pulses are sequentially output to the selection lines X11 through X90. As a result, the X coordinate signal line waveform 85 indicates that only voltage levels for the X11 sensor line through the X90 sensor line are serially converted and output.

Therefore, the detection time is assumed to be 80 times the cycle of the scan shift clock 68. The detection speed becomes three times faster than the untouched condition without changing the speed of the scan shift clock 68.

Also in FIG. 9, the scan start pulse cycle for touched condition 86 represents a cycle for the scan start pulse waveform 66 in touched condition and is equivalent to 80 lines. When the touched position corresponds to X90, the scan start pulse is input to the X51 scan start input. Pulses are sequentially output to the selection lines X51 through X130. As a result, the X coordinate signal line waveform 85 indicates that only voltage levels for the X51 sensor line through the X130 sensor line are serially converted and output.

Also in this case, the detection time is assumed to be 80 times the cycle of the scan shift clock 68. The detection speed becomes three times faster than the untouched condition without changing the speed of the scan shift clock 68.

The P/S conversion circuit 8 having the Y-coordinate scan range change function operates similarly. In this case, the Y direction corresponds to 320 lines. The detection speed becomes four times faster than the untouched condition.

As mentioned above, the control is provided to determine the scan range in touched condition around the touched position and implement the high-speed coordinate detection during pen input and the like.

The embodiment has described the configuration composed of the single touch panel. It is also possible to form the sensors and the scan control circuit according to the embodiment on a glass substrate forming a flat panel display such as a liquid crystal display.

The foregoing invention has been described in terms of preferred embodiments. However, those skilled, in the art will recognize that many variations of such embodiments exist. Such variations are intended to be within the scope of the present invention and the appended claims.

What is claimed is:

1. A touch panel device comprising:
a plurality of sensors arranged in matrix form;
a first sensor line wired to vertically output a first sensing signal for each of the sensors;
a second sensor line wired to horizontally output a second sensing signal for each of the sensors;
a first conversion circuit to parallel-to-serial convert the first sensing signal output to the first sensor line; and
a second conversion circuit to parallel-to-serial convert the second sensing signal output to the second sensor line,
wherein the first conversion circuit uses a variable range of parallel-to-serial converting the first sensing signal and a constant speed of parallel-to-serial converting the same in accordance with the first sensor line to output the first sensing signal; and
wherein the second conversion circuit uses a variable range of parallel-to-serial converting the second sensing signal and a constant speed of parallel-to-serial converting the same in accordance with the second sensor line to output the second sensing signal.

2. The touch panel device according to claim 1,
wherein, when the first sensing signal is unavailable, the first conversion circuit parallel-to-serial converts all the first sensing signals; and
wherein, when the second sensing signal is unavailable, the second conversion circuit parallel-to-serial converts all the second sensing signals.

3. The touch panel device according to claim 1,
wherein, when the first sensing signal is available, the first conversion circuit limits a range of parallel-to-serial converting the first sensing signal and determines a position to parallel-to-serial convert the first sensing signal with reference to a position of the first sensor line to output the first sensing signal; and
wherein, when the second sensing signal is available, the second conversion circuit limits a range of parallel-to-serial converting the second sensing signal and determines a position to parallel-to-serial convert the second sensing signal with reference to a position of the second sensor line to output the second sensing signal.

4. The touch panel device according to claim 1,
wherein the first conversion circuit determines a range of parallel-to-serial converting the first sensing signal by keeping track of moving positions of the first sensor line to output the first sensing signal; and
wherein the second conversion circuit determines a range of parallel-to-serial converting the second sensing signal by keeping track of moving positions of the second sensor line to output the second sensing signal.

5. A touched position sensing method for a touch panel device comprising: a plurality of sensors arranged in matrix form; a first sensor line wired to vertically output a first sensing signal for each of the sensors; a second sensor line wired to horizontally output a second sensing signal for each of the sensors; a first conversion circuit to parallel-to-serial convert and output the first sensing signal output to the first sensor line; and a second conversion circuit to parallel-to-serial convert and output the second sensing signal output to the second sensor line, the method comprising the steps of:
keeping a constant speed for parallel-to-serial conversion;
parallel-to-serial converting all the first sensing signals when the first sensing signal is unavailable;
limiting a range of parallel-to-serial converting the first sensing signal when the first sensing signal is available;
determining a position to parallel-to-serial convert the first sensing signal with reference to a position of the first sensor line to output the first sensing signal;
parallel-to-serial converting all the second sensing signals when the second sensing signal is unavailable;
limiting a range of parallel-to-serial converting the second sensing signal when the second sensing signal is available;
determining a position to parallel-to-serial convert the second sensing signal with reference to a position of the second sensor line to output the second sensing signal.

6. A touched position sensing method for a touch panel device comprising: a plurality of sensors arranged in matrix form; a first sensor line wired to vertically output a first sensing signal for each of the sensors; a second sensor line wired to horizontally output a second sensing signal for each of the sensors; a first conversion circuit to parallel-to-serial convert and output the first sensing signal output to the first sensor line; and a second conversion circuit to parallel-to-serial convert and output the second sensing signal output to the second sensor line, the method comprising the steps of:
keeping a constant speed for parallel-to-serial conversion;
parallel-to-serial converting all the first sensing signals when the first sensing signal is unavailable;
limiting a range for parallel-to-serial conversion by keeping track of moving positions of the first sensor line to output the first sensing signal when the first sensing signal is available;
determining a position to parallel-to-serial convert the first sensing signal with reference to a position of the first sensor line to output the first sensing signal;
parallel-to-serial converting all the second sensing signals when the second sensing signal is unavailable;
limiting a range for parallel-to-serial conversion by keeping track of moving positions of the second sensor line to output the second sensing signal when the second sensing signal is available; and
determining a position to parallel-to-serial convert the second sensing signal with reference to a position of the second sensor line to output the second sensing signal.

7. A touch panel device comprising:
a display panel;
a plurality of first sensor lines arranged on the display panel;
a plurality of second sensor lines which cross the plurality of first sensor lines and are arranged on the display panel;
a first circuit to scan the first sensor line at a first cycle; and
a second circuit to scan the first sensor line at a second cycle,
wherein, when a touch is detected from the first sensor line, the first circuit limits a range of scanning at the first cycle with reference to a touched position and scans the first sensor line at the first cycle; and
wherein, when a touch is detected from the second sensor line, the second circuit limits a range of scanning at the second cycle with reference to a touched position and scans the second sensor line at the second cycle.
